(19) United States
(12) Patent Application Publication
(10) Pub. No.: US 2005/0206820 A1
(43) Pub. Date: Sep. 22, 2005

(54) Fast optical shutter

(75) Inventor: Stephen Palmer, Borlange (SE)

Correspondence Address: SUGHRUE MION, PLLC, 2100 PENNSYLVANIA AVENUE, N.W., SUITE 800, WASHINGTON, DC, 20037, US

(73) Assignee: LC-TEC DISPLAYS AB, Borlange (SE)

(21) Appl. No.: 10/518,050

(22) PCT Filed: Jun. 18, 2003
(86) PCT No.: PCT/SE03/01040

§ 371 Date: Feb. 22, 2005

(30) Foreign Application Priority Data
Jun. 20, 2002 (SE) 0201905-7

(51) Int. Cl. G02F 1/1343

(52) U.S. Cl. 349/139

(57) ABSTRACT

A liquid crystal optical shutter is disclosed that possesses an aperture window (124) comprising of first and second electrode patterns (112; 212) arranged on respective planar substrates. The first and second substrates are provided at a predetermined mutual distance. The electrode patterns each comprises a series of row electrodes, wherein the series of row electrodes of the first electrode pattern are aligned at an angle of less than 45 degrees with the series of row electrodes of the second electrode pattern so as to create a high internal electrical resistance in series with any point in the liquid crystal optical shutter. It is thereby provided a high internal electrical resistance in series with any point in the liquid crystal optical shutter whilst the overall external resistance of the optical shutter is maintained at a low level, significantly reducing the occurrence of electrical sparking.

### FIELD OF INVENTION

The present invention relates generally to liquid crystal optical shutters that are to be operated with high electrical voltages and more specifically to a large sized, high voltage optical shutter using cholesteric liquid crystal materials.

### BACKGROUND OF THE INVENTION

A wide range of different types of optical shutters have been developed over the years. An optical shutter can in general be switched between two or more optical states upon application of an externally applied electric field. The different optical states possess different optical properties in terms of transmission, reflection and absorption.

An optical shutter according to the state of the art typically possesses an active area or aperture window consisting of one large picture element or “pixel” that can be turned ON or OFF, i.e. either being reflective or transparent. However, compared to liquid crystal displays (LCD's), for example, an optical shutter possesses a comparatively large aperture window; aperture windows as large as 400 mm*400 mm are not uncommon.

One type of optical shutter known to the art uses cholesteric liquid crystal materials. Here, the cholesteric liquid crystals can be electronically switched between a high light scattering state, referred to as the focal conic texture, and a transparent state, referred to as the homeotropic phase. Moreover, one technique known to the art results in the cholesteric liquid crystal optical shutter being highly transparent when activated with an applied voltage, and being highly light scattering when the voltage is removed.

Prior art discloses that a cholesteric liquid crystal optical shutter typically consists of two parallel planar substrates. The inner surfaces of the substrates are often coated with an electrically conducting thin layer or electrode, which is also predominantly optically transparent. Moreover, the electrodes are often coated with one or more insulation layers or hard coat layers in order to minimise the flow of electricity between said substrates. There may or may not also be an additional thin layer coating on top of the insulation layers in order to induce the required molecular alignment of the liquid crystal material at the surfaces of the two substrates.

The distance gap between the substrates is often controlled by the placing of small distance spheres or spacers between said substrates. The diameter of the spacers are accurately controlled, hence a precise and homogeneous cell gap is obtained. Furthermore, in order to obtain a high level of optical light scattering when in the focal conic texture, it is often necessary to use a large cell gap for a cholesteric liquid crystal optical shutter. Typical cell gaps of between 10 and 30 micrometers are often used.

The liquid crystal material is bounded between the two parallel substrates. When a voltage is applied to the contact surface of each electrode on each side of the cell, voltage acts on the liquid crystal material localised in the regions where said conducting layers on each side of the cell mutually overlap, hence switching the liquid crystal material in said regions to the required optical state. It is therefore the overlap regions between the two conducting layers on each side of the cell that make up the active area or aperture window of the optical shutter.

The switching speed of an optical shutter is defined as being the time taken for the optical shutter to change from one optical state to another. In many applications, a quick switching speed is required in order to rapidly modulate the passage of light through the optical device. Furthermore, it is known to one skilled in the art that fast switching speeds can be obtained by using high electrical fields to operate the liquid crystal material.

For example, an electric field strength of over 12 volts per micrometer can be used to rapidly switch a cholesteric liquid crystal optical shutter from the light scattering, focal conic texture, to the highly transparent homeotropic state. With a cholesteric liquid crystal optical shutter possessing a cell thickness of 20 micrometers, an externally applied voltage of over 240 volts hence is required. It is therefore often necessary to operate cholesteric liquid crystal optical shutters with ultra high voltages in order to attain the required speed in switching response.

Prior art discloses that the aperture window of a cholesteric liquid crystal optical shutter is often in the form of, but not limited to, a rectangle or oval. Such geometry of the electrodes on each side of the cell results in there being a low electrical resistance within the conducting layer of each substrate. For example, with an optical shutter possessing a square aperture window and using as the electrode material an indium-doped tin oxide (ITO) thin film possessing an intrinsic sheet resistance of 10 ohms per square, the total overall electrical resistance of each substrate will be only 10 ohms.

FIGS. 1a-c show the geometry of the electrodes employed in an optical shutter possessing a rectangular shaped aperture window according to the state of the art. FIG. 1a shows a first generally planar side or substrate plate 10 having a first electrode 12 provided thereon, whilst FIG. 1b shows a second generally planar side or substrate plate 20 having a second electrode 22 provided thereon. The substrates 10, 20 are arranged at a uniform mutual distance and liquid crystal material in the form of cholesteric liquid crystals (for the sake of clarity not shown in FIGS. 1a-c) is provided between the two plates 10 and 20. The mutual overlap 24 of the electrodes defines the aperture window.

Here, the low electrical resistance associated with the geometry of the electrodes on each side of the cell permits a high leakage current to flow through any defect spots present in the insulation layers, hence allowing for the occurrence of electrical break-down. A defect spot in one or more of the insulation layers in the liquid crystal cell such as, for example but not limited to, a pin-hole, crack or contaminant particle, may result in some electrical leakage current occurring at said defect point between the two cell substrates. Moreover, the low overall electrical resistance of the conducting layer on each substrate associated with the geometry of a rectangular or oval type aperture window according to the state of the art, results in there being little electrical resistance in series with the defect in order to limit the current leakage through said defect point. This current leakage and the associated local thermal heating of the defect spot may in turn lead to the occurrence of electrical sparking between the two substrates. Such electrical sparking may result in the formation of a burn-mark within the liquid crystal cell, visible as an optical defect.

The low overall electrical resistance of the conducting layers on both sides of the cell due to the geometry of the aperture window in a state of the art cholesteric liquid crystal optical shutter, together with the ultra high voltage required in order to attain adequate switching speeds, results in there being a high risk for the occurrence of electrical sparking between said substrates. This places a very high demand on the manufacturing quality of a cholesteric liquid crystal optical shutter. In particular, it is known to one skilled in the art that the number of defect spots present in the insulation layers covering the two electrodes on the substrates of the liquid crystal cell should be reduced to a minimum.

Furthermore, as the size or area of the optical shutter increases, there is an increased risk that such defects occur due to manufacturing tolerances. It has therefore proved difficult to manufacture large sized, cholesteric liquid crystal optical shutters using state of the art electrode designs that are to be operated with high voltages.

Prior art describes one technique that can be used to reduce the risk of occurrence of electrical sparking within a cholesteric liquid crystal optical shutter, whereby either extra-thick insulation layers or several stacked layers of insulation coatings are applied to the inner surfaces of both sides of the cell. However, such cell designs are complicated to manufacture and significantly increase manufacturing costs.

### SUMMARY OF THE INVENTION

An object of the present invention is to provide a liquid crystal optical shutter possessing a large area aperture window, which is designed so that the optical shutter can be operated with high voltages without electrical sparking occurring between the two cell substrates.

The invention is based on the insight that by changing the geometry of the conducting layers or electrodes on the inner surfaces of the two substrates of the cell, the internal electrical resistance in series with any given defect spot can be significantly increased and moreover is also homogenous over the entire surface area of the aperture window. This series resistance limits the leakage current which is able to flow through the defect spot and hence prevents electrical sparking from occurring.

Furthermore, the geometry of the conducting layers is designed so that the total overall resistance of the liquid crystal cell as a whole remains low. This is an important criterion in order to allow for the rapid electrical capacitive charge and discharge of the liquid crystal cell and hence allow for fast optical shutter switching speeds.

According to the invention there is provided a liquid crystal optical shutter according to claim 1. Thus, there is provided an optical shutter wherein first and second electrode patterns each comprises a series of essentially parallel row electrodes, wherein the series of row electrodes of the first electrode pattern are aligned at an angle of less than 45 degrees with the series of row electrodes of the second electrode pattern, so as to create a high internal electrical resistance in series with any point in the liquid crystal optical shutter, whilst also maintaining the overall external resistance of the optical shutter at a low level.

With the inventive optical shutter, the drawbacks of prior art optical shutters are avoided or at least mitigated. By using the inventive idea, large sized liquid crystal optical shutters can be designed such that the occurrence of electrical sparking is significantly reduced.

Moreover, by designing the conducting layers so that the total overall resistance of the liquid crystal cell as a whole remains low, the rapid electrical capacitive charge and discharge of the liquid crystal cell is permitted, hence allowing for a fast optical shutter switching speeds.

In a preferred embodiment, the series of row electrodes of the first electrode pattern are aligned at an angle of less than 25 degrees, preferably less than 10 degrees, and most preferably essentially parallel with the series of row electrodes of the second electrode pattern.

In a further preferred embodiment, the maximum distance between adjacent regions of the electrode patterning on a given substrate surface is kept below a critical distance. This enables the fringe voltage at the edges of the electrodes to simultaneously activate the liquid crystal material bounded in the gap regions between the electrode patterning structure. The activation of the liquid crystal material in said gap regions prevents the electrode patterning layout from being visually apparent in the optical shutter.

Further preferred embodiments are defined in the dependent claims herein.

### BRIEF DESCRIPTIONS OF THE DRAWINGS

The invention is now described, by way of example, with reference to the accompanying drawings, in which:

FIGS. 1a and 1b show the electrode geometry on the respective sides of the cell for an optical shutter possessing a rectangular aperture window according to the state of the art;

FIG. 1c shows the combined electrode geometry in the complete liquid crystal cell for the two sides shown in FIGS. 1a and 1b;

FIGS. 2a and 2b show the electrode geometry on the respective sides of the cell for an optical shutter according to an embodiment of the present invention;

FIG. 2c shows the combined electrode geometry in the complete liquid crystal cell for the two sides shown in FIGS. 2a and 2b;

FIG. 3 is a sectional view of an optical shutter according to the invention showing the fringe voltage at the edges of the rows in the electrode pattern;

FIG. 4 is a sectional view of an alternative embodiment of an optical shutter according to the invention;

FIGS. 5a and 5b show the electrode geometry on the respective sides of the cell for an optical shutter according to an alternative embodiment of the present invention; and

FIG. 5c shows the combined electrode geometry in the complete liquid crystal cell for the two sides shown in FIGS. 5a and 5b.

### DETAILED DESCRIPTION OF THE INVENTION

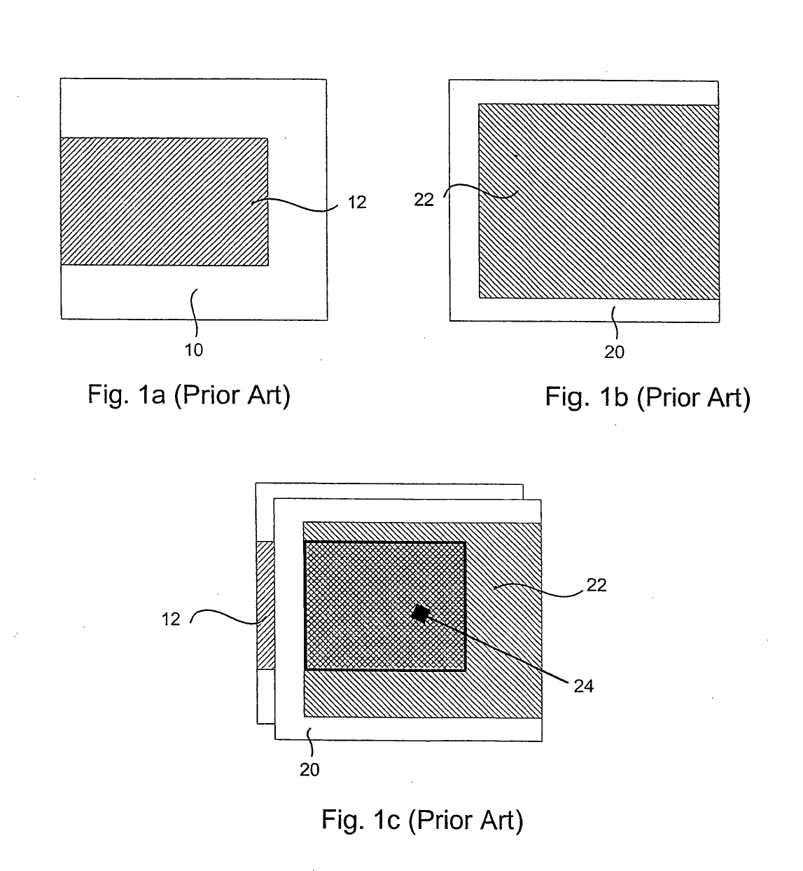

FIGS. 1a-c have been discussed in connection with prior art and will therefore not be dealt with further.

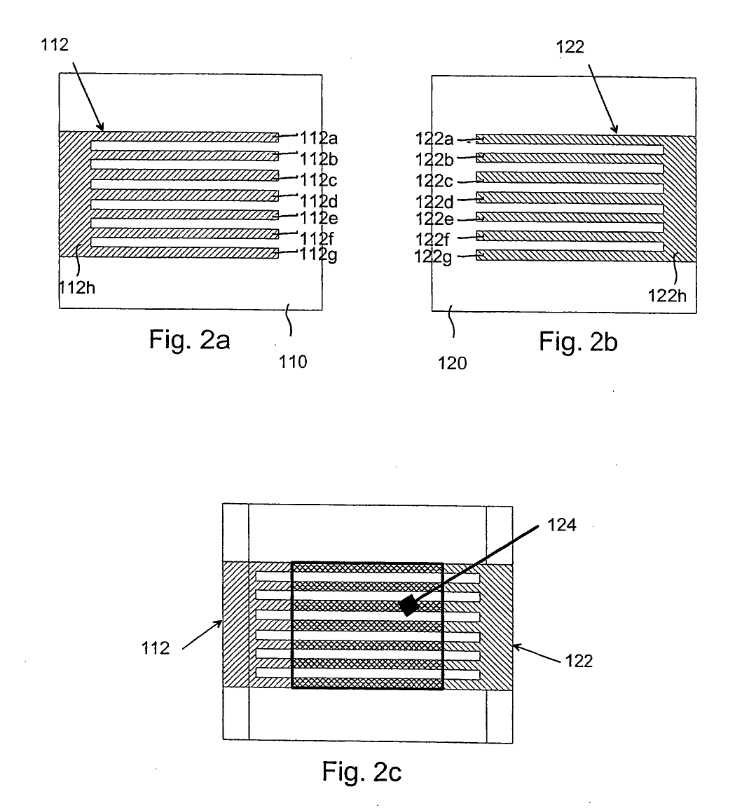

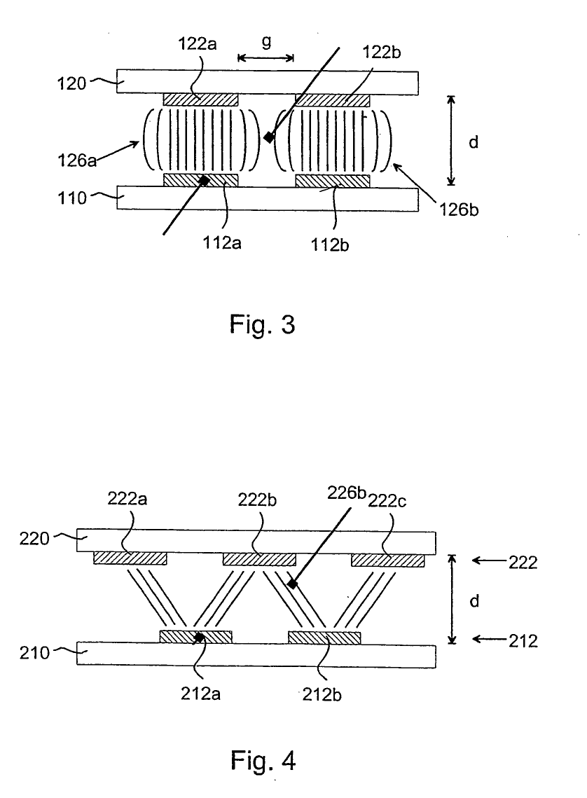

FIG. 2 show an electrode geometry patterning in an optical shutter possessing a rectangular shaped aperture window according to an embodiment of the present invention. FIG. 2a shows a first generally planar side or substrate plate 110 having a first electrode pattern 112 provided thereon, whilst FIG. 2b shows a second generally planar side or substrate plate 120 having a second electrode pattern 122 provided thereon. The substrates 110, 120 are arranged at a uniform mutual distance d, see FIG. 3, and liquid crystal material in the form of cholesteric liquid crystals (for the sake of clarity not shown in the figures) is provided between the two plates 110 and 120.

The first electrode pattern 112 comprises a series of geometrically linear and mutually parallel rows 112a-g of electrode material with constant thickness. The series of rows are electrically connected in parallel with each other by all rows being connected directly to the same first contact surface 112h at one end of the substrate, hence the same electrical voltage is applied to all rows simultaneously. Here, the rows are electrically connected in parallel with each other internally on the substrate surface.

The second electrode pattern 122 is a mirror image of the first electrode pattern, comprising a series of rows 122a-g electrically connected in parallel with each other by means of a second contact surface 122h located along an edge of the substrate 120 opposite from the edge where the first contact surface is located.

The rows of the first electrode pattern 112 are aligned essentially in parallel with and overlapping the rows of the second electrode pattern 122.

The mutual overlap of the electrodes defines the rectangular shaped aperture window 124. As is evident from FIG. 2c, the aperture window consists of a series of parallel electrode rows on each side of the cell. Moreover, the two sets of rows on the two substrates of the cell are oriented such that they are predominantly mutually parallel.

Due to the electrode patterning structure, there is a high internal electrical resistance in series with any given defect point that may be present in the insulation layers of the liquid crystal cell. The high series resistance limits the magnitude of the leakage current able to flow through said defect point, hence mitigating the occurrence of electrical break-down.

Moreover, the aperture window according to the present invention ensures that the electrical resistance in series with a given defect point is exactly the same over the entire surface area of the aperture window, independent of the location of the defect spot in the liquid crystal cell.

Furthermore, the fringe voltage at the edges of each row are perturbed and extend a certain distance into the gap regions between the rows, shown in FIG. 3, which is a detailed cross sectional view of the aperture window of FIG. 2c. In FIG. 3 there is shown the first 110 and second 120 substrate plates having electrode rows 112a, 112b and 122a, 122b, respectively, provided on the inner surfaces. Voltage fields 126a, 126b are shown in the figure extending between the first and second electrode rows. At the edges of the row electrodes, the voltage field is slightly curved or perturbed, forming a so-called fringe voltage that extends outside of the edges of the electrodes.

It is known to one skilled in the art that the extension distance of the fringe voltage is given as being approximately twice the cell gap distance, shown as distance “d” in FIGS. 3 and 4. For example, with a cell gap of 20 micrometers, the fringe voltage will extend approximately 40 micrometers into the gap regions between the edges of the different row electrodes.

It is preferred that the maximum distance g, see FIG. 3, between two adjacent rows on a given substrate is kept below the distance at which the fringe electric field extends into the gap region. This ensures that the voltage applied to the electrodes on each side of the cell activate not only the liquid crystal material bounded by the mutual overlap of the rows on either side of the cell, but also the liquid crystal material localised in the gap regions between said rows. This ensures that the electrode patterning on both sides of the cell is not visually apparent in the complete optical shutter.

The total overall resistance of the complete liquid crystal cell as a whole remains low when using the disclosed geometric electrode structure. This ensures that the electrical capacitive charging and discharging times for the liquid crystal optical shutter are minimised, hence allowing for a fast switching response between the optical states.

For example, with an optical shutter possessing a rectangular shaped aperture window of length L and width W, consisting of a series of linear and mutually parallel rows according to an embodiment of the present invention of thickness T and employing as the electrode material a transparent conducting thin film with an intrinsic sheet resistance of R, the total electrical resistance of each electrode row on a given substrate will be (L*R/T). This will be the total electrical resistance in series with any given defect spot that may be present in the insulation layers of the liquid crystal cell and will limit the leakage current able to flow through said defect spot, hence preventing the occurrence of electrical sparking. Furthermore, the total number of rows making up the aperture window of the optical shutter is given by (W/T).

Assuming that the gaps between the rows are negligible, the total resistance of each substrate surface in the liquid crystal optical shutter is found by summating together all row resistances connected in parallel, given by 1/(T/L*R)*(W/T)=(L/W)*R. It is known to one skilled in the art that this result is exactly the same overall total resistance that the substrates in an optical shutter possessing an unpatterned rectangular aperture window consisting of a single rectangular pixel would have according to prior art. The total overall resistance of the optical shutter possessing an aperture window according to the present invention is therefore identical to that for an optical shutter that possesses an unpatterned, single-pixel aperture window according to the state of the art and hence the total resistance of the cell is maintained at a low level in order to enable for the rapid electrical capacitive charging and discharging of the liquid crystal cell.

More specifically, for a cholesteric liquid crystal optical shutter with dimensions of 400 mm*400 mm using the disclosed electrode design consisting of electrode rows of width 0.1 mm and using an electrode material possessing an intrinsic sheet resistance of 100 ohms per square, the total resistance of each row is given by (L*R)/T=0.4 MΩ. It is this internal resistance that is in series with any given defect spot in the cell and hence limits the current that can flow through said defect spot. Furthermore, the total resistance of each substrate surface in the complete liquid crystal optical shutter as a whole is given by (L/W)*R=100 ohms.

Moreover, if the cell gap is 20 micrometers and the gaps between the rows on each substrate is less than approximately 40 micrometers, then the fringe voltage will activate the liquid crystal material in the gap regions and consequently the electrode patterning will not be visually apparent in the complete optical shutter.

An alternative embodiment of an optical shutter according to the invention is shown in FIG. 4. As with the first embodiment described with reference to FIGS. 2a-c and 3, this second embodiment of an optical shutter comprises a first generally planar side or substrate plate 210 having a first electrode pattern 212 provided thereon and a second generally planar side or substrate plate 220 having a second electrode pattern 222 provided thereon.

However, in this second embodiment the electrode rows 212a, b of the first electrode pattern are positioned so that they overlap the electrode gaps of the second electrode pattern. The resulting lateral voltage field will help to activate the liquid crystal material in the gap regions and hence ensure that the electrode patterning is not visually apparent in the optical shutter.

Prior art discloses the passive matrix liquid crystal display. Here, there exists a series of electrode rows on one side of the liquid crystal cell and a series of electrode columns on the other side of said cell. The rows and columns are oriented predominantly perpendicular to each other and the mutual overlap of a row on one side of the cell with a column on the other side of said cell defines a picture element or pixel in the liquid crystal display. Voltage is applied independently to each row and each column separately and an image is scanned into the display row-by-row.

The electrode patterning of a liquid crystal optical shutter according to the present invention differs from the design of the state of the art passive matrix display in that the two sets of electrode rows on the two substrate surfaces in the liquid crystal cell are oriented predominantly parallel with each other. Moreover, the series of rows on each side of the cell are electrically connected in parallel so that the same electrical voltage is applied to all rows simultaneously.

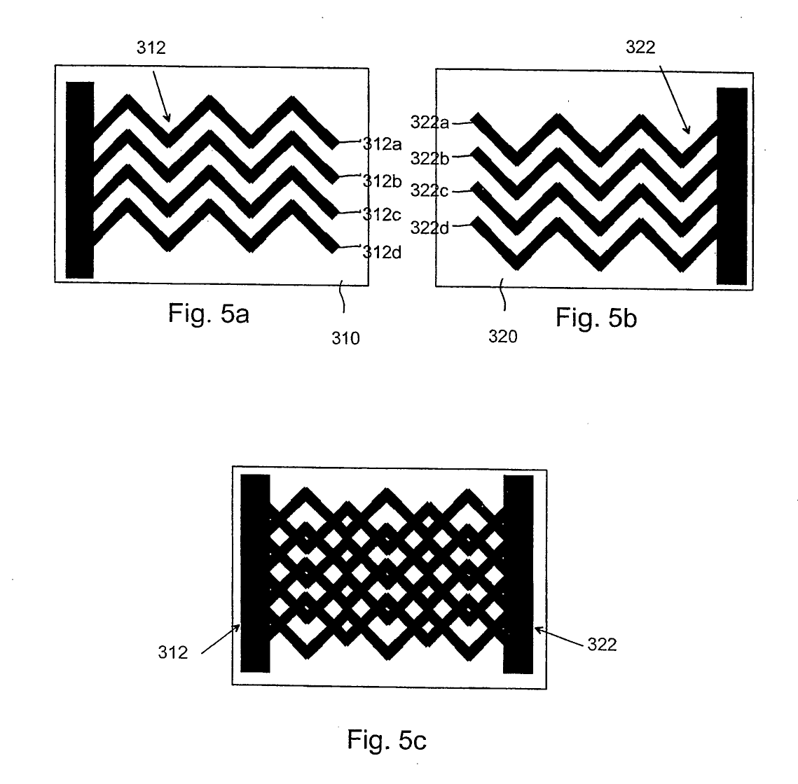

In the embodiment described with reference to FIGS. 2a-c, the row electrodes have been generally straight. However, in an alternative embodiment shown in FIGS. 5a-c, the individual row electrodes of the electrode patterns have a zigzag shape. Thus, the first electrode pattern 312 comprises a series of zigzag shaped but still mutually parallel rows 312a-d of electrode material with constant thickness. The series of rows are electrically connected in parallel with each other by all rows being connected directly to the same first contact surface at one end of the substrate, hence the same electrical voltage is applied to all rows simultaneously.

The second electrode pattern 322 is a mirror image of the first electrode pattern, comprising a series of rows 322a-d electrically connected in parallel with each other by means of a second contact surface 322e located along an edge of the substrate 320 opposite from the edge where the first contact surface is located.

Although the overall geometrical shape of the rows of the first and second electrode patterns 312, 322 are straight and essentially mutually parallel as in the first embodiment shown in FIGS. 2a-c, they locally intersect each other at a relatively high angle, illustrated in FIG. 5c. This configuration once again provides for a high and homogeneous internal electrical resistance in series with any defect spots that may be present in the liquid crystal cell, whilst maintaining the overall external resistance of the cell at a low level.

Whilst preferred embodiments have been shown and described herein, various modifications may be made thereto without departing from the inventive idea of the present invention. Accordingly, it is to be understood that the present invention has been described by way of illustration and not limitation.

Cholesteric liquid crystals have been described together with the optical shutter according to the invention. However, any liquid crystals exhibiting similar characteristics as cholesteric liquid crystals can be used with the present invention.

It will be obvious to one skilled in the art that other liquid crystal cell optical shutter constructions are also possible that allow for a high internal series resistance to be provided for by patterning of the electrodes on the inner surfaces of each substrate in the liquid crystal cell. For example, the two sets of electrode rows on the two substrate surfaces may be oriented such that there exists a small intersection angle between said sets of rows. This mutual intersection angle could be as high as 45 degrees, although an intersection angle of less than 25 degrees is preferred and an intersection angle of less than 10 degrees is even more preferred. However, the preferred embodiment is when the two sets of rows are essentially mutually parallel, as illustrated herein. Although a non-zero intersection angle between the two sets of rows on the two substrate surfaces would not minimise the overall total electrical resistance of the cell, a high internal resistance is never-the-less obtained that will help to mitigate the occurrence of electrical sparking in said optical shutter.

Furthermore, a rectangular aperture window has been described herein. It will be appreciated that the aperture window can also take other geometric shapes as well, such as an oval or circular shape. This can be obtained by providing non-linear electrodes, such as curved electrodes. Also, the electrode rows are not necessarily required to have a uniform and constant width along their entire length and the electrode rows are not required to all have the same width as each other.

Although the rows of each electrode have been shown to be electrically connected in parallel internally on each of the two substrates, they could also be electrically connected in parallel externally from the substrates by other means.

1. A liquid crystal optical shutter having an aperture window, said optical shutter comprising:
a first electrode pattern arranged on a first essentially planar substrate,
a second electrode pattern arranged on a second essentially planar substrate, wherein the first and second substrates are provided at a predetermined mutual distance (d), and
liquid crystal material provided between the first and second substrates,
wherein
the first and second electrode patterns each comprises a series of essentially parallel row electrodes,
wherein the series of row electrodes of the first electrode pattern are aligned at an angle of less than 45 degrees with the series of row electrodes of the second electrode pattern so as to create a high internal electrical resistance in series with any point in the liquid crystal optical shutter, whilst maintaining the overall external resistance of the optical shutter at a low level.

2. The optical shutter according to claim 1, wherein the series of row electrodes of the first electrode pattern are aligned at an angle of less than 25 degrees, preferably less than 10 degrees, and most preferably essentially parallel with the series of row electrodes of the second electrode pattern.

3. The optical shutter according to claim 1, wherein the row electrodes of at least one electrode pattern are electrically connected in parallel.

4. The optical shutter according to claim 1, wherein each of the electrode patterns comprises a contact surface electrically connecting the row electrodes in parallel.

5. The optical shutter according to claim 4, wherein the contact surface of the first electrode pattern and the contact surface of the second electrode pattern are provided on opposite edges of the optical shutter.

6. The optical shutter according to claim 1, wherein the row electrodes of the first electrode pattern are positioned so that they overlap the electrode gaps of the second electrode pattern and vice versa.

7. The optical shutter according to claim 1, wherein the row electrodes of the first electrode pattern are positioned so that they overlap the row electrodes of the second electrode pattern and vice versa.

8. The optical shutter according to claim 1, wherein the maximum distance (g) between the row electrodes of at least one of said electrode patterns is less than approximately twice the mutual distance (d) between the first and second substrates.

9. The optical shutter according to claim 1, wherein the mutual distance (d) between the first and second substrates is between 4 micrometers and 40 micrometers, and more preferably between 10 micrometers and 30 micrometers.

10. The optical shutter according to claim 1, wherein the optical shutter is arranged to be operated with voltages of between 50 volts and 300 volts, and more preferably between 100 volts and 200 volts.

11. The optical shutter according to claim 1, wherein the optical shutter is arranged to be switched between a high light scattering state, and a high transparent state

12. The optical shutter according to claim 1, wherein the liquid crystal material comprises cholesteric liquid crystals.

13. The optical shutter according to claim 1, wherein the row electrodes on at least one of the substrates consists at least in part of a series of geometrically linear lines, preferably with constant thickness.

14. The optical shutter according to claim 1, wherein the row electrodes on at least one of the substrates consists at least in part of a series of rows that are non-linear.

15. The optical shutter according to claim 1, wherein the row electrodes on at least one of the substrates consists at least in part of a series of zigzag lines, preferably with constant thickness.
